(19) United States
(12) Patent Application Publication
(10) Pub. No.: US 2024/0202841 A1
(43) Pub. Date: Jun. 20, 2024

(54) SYSTEM AND METHOD TO MEASURE EFFECTIVENESS OF AN EVENT

(71) Applicant: Ashwin Razdan, Halifax (CA)

(72) Inventor: Ashwin Razdan, Halifax (CA)

(21) Appl. No.: 18/555,996

(22) PCT Filed: Jun. 4, 2021
(86) PCT No.: PCT/IB2021/054916

§ 371 Date: Oct. 18, 2023

(30) Foreign Application Priority Data
Apr. 19, 2021 (IN) 202111018005

(51) Int. Cl. G06Q 50/00

(52) U.S. Cl. CPC G06Q 50/01

(57) ABSTRACT

System and method to measure effectiveness of an event are provided. The system includes a data retrieving module configured to retrieve responses corresponding to multimedia. associated to the event; a multimedia processing module configured to process the multimedia using a processing technique to identity one or more parameters; a multimedia segregation module configured to segregate the multimedia into categories based on pre-defined set of instructions; a parameter weightage generation module configured to assign a pre-defined value representative of a weightage associated to the corresponding parameters; a multimedia rationalization module configured to rationalize data associated to the multimedia to a pre-defined target value; a data scaling module configured to generate a scaling value for multimedia; a score generation module configured to generate a score for multimedia based on the scaling value generated to measure effectiveness of the event.

### EARLIEST PRIORITY DATE

This Application claims priority from a Complete patent application filed in India having Patent Application No. 202111018005, filed on Apr. 19, 2021 and titled “SYSTEM AND METHOD TO MEASURE EFFECTIVENESS OF AN EVENT”.

### FIELD OF INVENTION

Embodiments of a present invention relate to measuring an effectiveness of an event, and more particularly, to system and method to measure effectiveness of event.

### BACKGROUND

An event is defined as a planned public or social occasion. With the linear growth in the technology, any event such as a conference, a lecture, a play, or the like are being displayed on any social media platforms to make it reach to a vast range of public in one or the other forms such as a video, a graphic, images or the like. However, monitoring a success ratio of such events is to be monitored. In conventional approaches, systems which are used to monitor such success ratio or the effectiveness of the events do not include any definitive metric for measurement of success for content on Social platforms. For example, in such conventional approach, each social platform dictates different metrics and focusses on ‘views’ and not on its impact on the consumer. Due to such limitation, the conventional systems cannot determine which content works better, and what format of content works better, thereby making such system less reliable and less efficient.

Hence, there is a need for an improved system and method to measure effectiveness of event to address the aforementioned issues.

### BRIEF DESCRIPTION

In accordance with one embodiment of the disclosure, a system to measure effectiveness of an event is disclosed. The system includes one or more processors. The system also includes a data retrieving module configured to retrieve one or more responses corresponding to at least one multimedia, wherein the multimedia is associated to the event. The system also includes a multimedia processing module configured to process the at least one multimedia using a processing technique to identity one or more parameters from the corresponding at least one multimedia. The system also includes a multimedia segregation module configured to segregate the at least one multimedia into one or more categories based on one or more pre-defined set of instructions. The system also includes a parameter weightage generation module configured to assign a pre-defined value representative of a weightage associated to the corresponding one or more parameters, based on one or more segregated categories. The system also includes a multimedia rationalization module configured to rationalize data associated to the at least one multimedia to a pre-defined target value. The system also includes a data scaling module configured to generate a scaling value for each of the at least one multimedia. The system also includes a score generation module configured to generate a score for each of the at least one multimedia based on the scaling value generated to measure effectiveness of an event.

In accordance with one embodiment of the disclosure, a method for measuring effectiveness of an event is disclosed. The method includes retrieving one or more responses corresponding to at least one multimedia, wherein the multimedia is associated to the event. The method also includes processing the at least one multimedia using a processing technique for identifying one or more parameters from the corresponding at least one multimedia. The method also includes segregating the at least one multimedia into one or more categories based on one or more pre-defined set of instructions. The method also includes assigning a pre-defined value representative of a weightage associated to the corresponding one or more parameters, based on one or more segregated categories. The method also includes rationalizing data associated to the at least one multimedia to a pre-defined target value. The method also includes generating a scaling value for each of the at least one multimedia. The method also includes generating a score for each of the at least one multimedia based on the scaling value generated to measure effectiveness of an event.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to measure effectiveness of an event in accordance with an embodiment of the present disclosure;

FIG. 2 is a block diagram representation of an exemplary embodiment of the system to measure effectiveness of a video shared on a social media platform of FIG. 1 in accordance with an embodiment of the present disclosure;

FIG. 3 is a block diagram representation of a processing subsystem located on a local server or on a remote server in accordance with an embodiment of the present disclosure; and

FIGS. 4a and 4b are flow charts representing steps involved in a method for measuring effectiveness of an event in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method to measure effectiveness of an event. The system includes one or more processors. The system also includes a data retrieving module configured to retrieve one or more responses corresponding to at least one multimedia, wherein the multimedia is associated to the event. The system also includes a multimedia processing module configured to process the at least one multimedia using a processing technique to identity one or more parameters from the corresponding at least one multimedia. The system also includes a multimedia segregation module configured to segregate the at least one multimedia into one or more categories based on one or more pre-defined set of instructions. The system also includes a parameter weightage generation module configured to assign a pre-defined value representative of a weightage associated to the corresponding one or more parameters, based on one or more segregated categories. The system also includes a multimedia rationalization module configured to rationalize data associated to the at least one multimedia to a pre-defined target value. The system also includes a data scaling module configured to generate a scaling value for each of the at least one multimedia. The system also includes a score generation module configured to generate a score for each of the at least one multimedia based on the scaling value generated to measure effectiveness of an event.

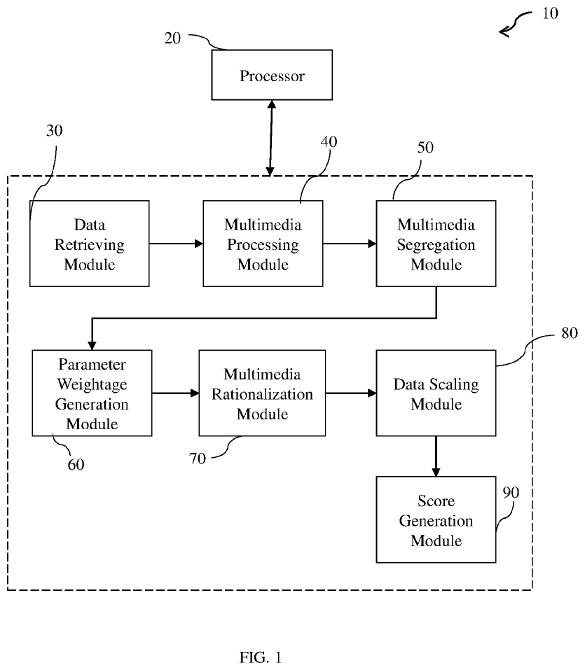

FIG. 1 is a block diagram representation of a system (10) to measure effectiveness of an event in accordance with an embodiment of the present disclosure. In one embodiment, the event may be a lecture, a short video, a movie, a short movie, a music album, or the like which may be represented in a form a multimedia. The system (10) includes one or more processors (20). The system (10) also includes a data retrieving module (30) which is configured to retrieve one or more responses corresponding to at least one multimedia. In 20 one embodiment, the at least one multimedia may include one of a text message, an audio message or a video message. In one exemplary embodiment, the at least one response may include a response shared by one or more users upon viewing the at least one multimedia on one of a social media platform, a centralised platform, a decentralized platform, a public platform, a private platform, or the like. In such embodiment, the at least one multimedia may be viewed by a computing device of the corresponding one or more users. The computing device may be one of a mobile phone, a laptop, a tablet, or the like.

The system (10) also includes a multimedia processing module (40) configured to process the at least one multimedia using a processing technique to identity one or more parameters from the corresponding at least one multimedia. In one embodiment, the at least one processing technique may include one of a machine learning technique, an artificial intelligence technique, a deep learning technique, or the like. As used herein, the term “artificial intelligence (AI)” is defined as an intelligence demonstrated by machines to perform or mimic human intelligence and human behavior. Also, the term “Machine learning (ML)” is defined as a study of computer algorithms that improve automatically through experience upon leaning using a built model which is based on a sample set of data. In one exemplary embodiment, the AI technique may include a natural language processing technique. In one embodiment, the ML technique may include one of a supervised technique. Further, the term “deep learning technique” also known as deep structured learning may be defined as part of a broader family of machine learning methods based on artificial neural networks with representation learning. Learning can be supervised, semi-supervised or unsupervised. In one exemplary embodiment, a learning model may be built using the pre-defined set of instruction which may be used for the further processing and analysis.

Furthermore, the system (10) includes a multimedia segregation module (50) configured to segregate the at least one multimedia into one or more categories based on one or more pre-defined set of instructions. In one embodiment, the one or more categories may include at least one of a domain, duration of the corresponding at least one multimedia, a brand, national, vernacular, or a combination thereof. For example, if the event is a lecture on mathematics topic which may be shared among a plurality of students, which may be shared on any of the social media platform for the student's learning, the domain may be education. Such domain may be identified by the system (10) using the learning model which may be built. The learning model may keep learning and enhancing the ability after every execution may be performed.

The system (10) also includes a parameter weightage generation module (60). The parameter weightage generation module (60) is configured to assign a pre-defined value representative of a weightage associated to the corresponding one or more parameters, based on one or more segregated categories. More specifically, each of the at least one multimedia may be assigned a corresponding value in terms of weightage which may be representative of a percentage value, a pointer value or the like. Such weightage may be assigned based on a benchmark value which may be defined in a set of pre-defined instructions. In one embodiment, the segregated category may be assigned certain weights based on the responses of the one or more user for a plurality of similar content as that of each of the corresponding at least one multimedia. Referring to the above example, based on the number of views of the mathematic video by the plurality of students, the weightage for the corresponding video may be defined by the weightage generation module (60). If most of the students have viewed the video, and if most of the students have viewed the complete video, the weightage for the corresponding video is set high. If the number of views and the duration of viewing of the video by the students is less than a pre-defined values, then the weightage for the video is less.

The system (10) also includes a multimedia rationalization module (70) which is configured to rationalize data associated to the at least one multimedia to a pre-defined target value. In one embodiment, the all the acquired data may be rationalized to reach a pre-defined number of users. The pre-defined number of users may be based on content of the corresponding at least one multimedia.

Furthermore, the system (10) includes a data scaling module (80) configured to generate a scaling value for each of the at least one multimedia. In one embodiment, the scaling value may include one of a minimum score or a maximum score based on the one or more parameters associated to the event. As used herein, the term “event” may represent or may be associated to the content of the corresponding at least one multimedia. In one embodiment, one or more parameters may include at least one of a like, an emoji, a share, a comments, number of views, cost per click (CPC), cost per visit (CPV), cost per mile (CPM), or a combination thereof associated to the corresponding at least one multimedia, wherein the one or more parameters are decided by one or more viewers.

The system (10) further includes a score generation module (90) configured to generate a score for each of the at least one multimedia based on the scaling value generated to measure effectiveness of an event. In one embodiment, the score value for the defined based on at least one of the one or more parameter, the one or more categories, the weightage calculated, the scaling value or a combination thereof, for each of the corresponding at least one multimedia. In one exemplary embodiment, the score may be generated using at least one of the machine learning technique, the artificial intelligence technique, the deep learning technique, or the like.

In one exemplary embodiment, the system (10) may further include an event prediction module which may be configured to predict one of a status, a performance of the corresponding at least one multimedia, or a combination thereof using one of the artificial intelligence technique, the machine learning technique or the deep learning technique. The prediction may be utilized by an authorized user generating the at least one multimedia to enhance or modify the corresponding content of the multimedia to gain more weightage.

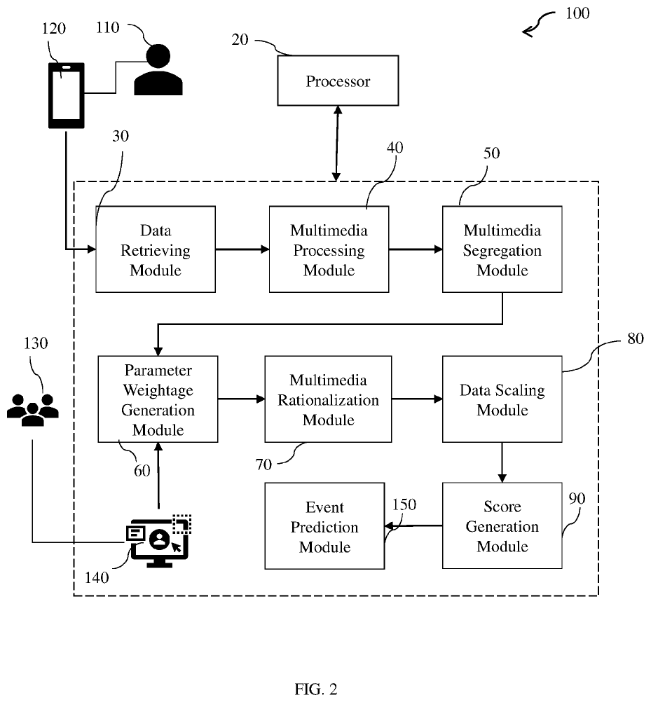

FIG. 2 is a block diagram representation of an exemplary embodiment of the system (100) to measure effectiveness of an awareness video shared on a social media platform of FIG. 1 in accordance with an embodiment of the present disclosure. The system (100) includes a data retrieving module (30), a multimedia processing module (40), a multimedia segregation module (50), a parameter weightage generation module (60), a multimedia rationalization module (70), a data scaling module (80) and a score generation module (90) which are substantially similar to system (10), a data retrieving module (30), a multimedia processing module (40), a multimedia segregation module (50), a parameter weightage generation module (60), a multimedia rationalization module (70), a data scaling module (80) and a score generation module (90) of FIG. 1.

A user ‘X’ (110) generates the awareness video using a user device (120). The generated awareness video is uploaded to a social media platform using the user device (120). The video uploaded on the social media platform is retrieved using the data retrieving module (30). The retrieved video is processed using the multimedia processing module (40) to identify the one or more parameters such as number of views off the video the kind of comments for the video the kind of lights or emojis generated by a plurality of viewers (130) for the video uploaded on the social media platform losing a corresponding viewer device (140). Further on retrieving the parameters the video is segregated into a corresponding category that is since the awareness video belongs to an educational category the video may be segregated under the educational domain by the multimedia segregation module (50). Further based on the parameters identified the parameter weightage generation module (60) generator voltage value for the awareness video. Furthermore, the multimedia rationalization module (70) rationalizes the awareness video to a preset value of 50,000 views for example. Consequently, a scaling value for a maximum view is generated by the data scaling module (80). Based on all the above performed analysis and processes the score generation module (90) generates a unique score for the associated awareness video which may be displayed on the social media platform or maybe displayed on an interface of the user device (120) for the user to nor the scaling value for the generated awareness video.

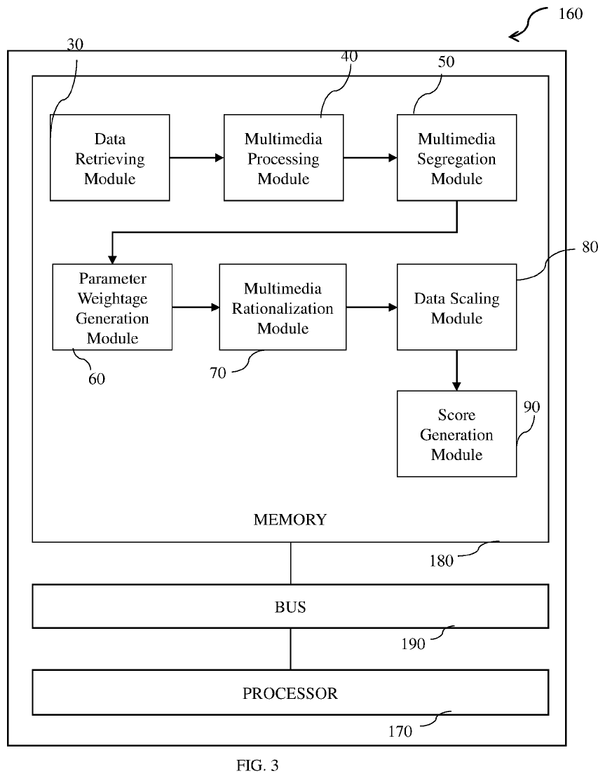

FIG. 3 is a block diagram representation of a processing subsystem located on a local server or on a remote server in accordance with an embodiment of the present disclosure. The server (160) includes processor(s) (170), and a memory (180) coupled to a bus (190). As used herein, the processor(s) (170) and the memory (180) are substantially similar to the system (10) of FIG. 1. Here, the memory (180) is located in a local storage device.

The processor(s) (170), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) (170).

The memory (180) includes a set of instructions in the form of executable program which instructs the processor(s) (170) to perform method steps illustrated in FIG. 3. The memory (180) includes the following module: a data retrieving module (30), a multimedia processing module (40), a multimedia segregation module (50), a parameter weightage generation module (60), a multimedia rationalization module (70), a data scaling module (80) and a score generation module (90).

The data retrieving module (30) is configured to retrieve one or more responses corresponding to at least one multimedia. The multimedia processing module (40) is configured to process the at least one multimedia using a processing technique to identity one or more parameters from the corresponding at least one multimedia. The multimedia segregation module (50) is configured to segregate the at least one multimedia into one or more categories based on one or more pre-defined set of instructions. The parameter weightage generation module (60) is configured to assign a pre-defined value representative of a weightage associated to the corresponding one or more parameters, based on one or more segregated categories. The multimedia rationalization module (70) is configured to rationalize data associated to the at least one multimedia to a pre-defined target value. The data scaling module (80) is configured to generate a scaling value for each of the at least one multimedia. The score generation module (90) is configured to generate a score for each of the at least one multimedia based on the scaling value generated to measure effectiveness of an event.

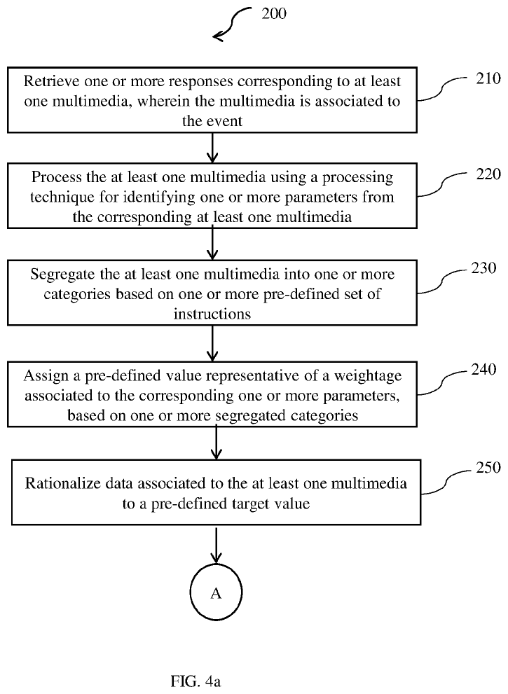

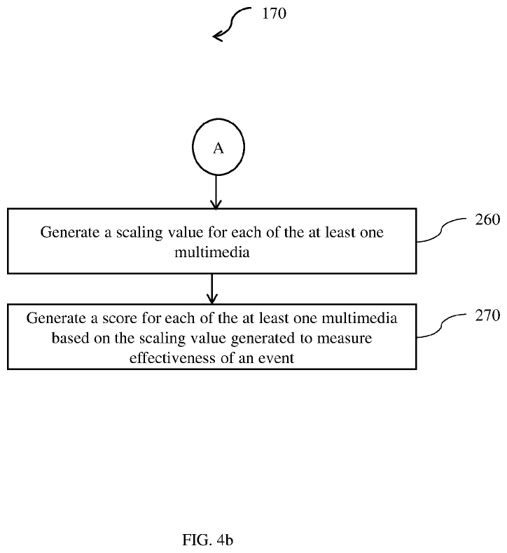

FIGS. 4a and 4b are flow charts representing steps involved in a method (200) for measuring effectiveness of an event in accordance with an embodiment of the present disclosure. the method includes retrieving one or more responses corresponding to at least one multimedia, wherein the multimedia is associated to the event in step 210. In one embodiment, retrieving the one or more responses may include retrieving one or more responses by a data retrieving module.

The method (200) also includes processing the at least one multimedia using a processing technique for identifying one or more parameters from the corresponding at least one multimedia in step 220. In one embodiment, identifying one or more parameters may include identifying one or more parameters by a multimedia processing module. In one exemplary embodiment, identifying the one or more parameters may include identifying at least one of a like, an emoji, a share, a comments, number of views, cost per click (CPC), cost per visit (CPV), cost per mile (CPM), or a combination thereof associated to the corresponding at least one multimedia.

Furthermore, the method (200) includes segregating the at least one multimedia into one or more categories based on one or more pre-defined set of instructions in step 230. In one embodiment, segregating the at least one multimedia may include segregating the at least one multimedia by a multimedia segregation module. In one exemplary embodiment, segregating the at least one multimedia into one or more categories may include segregating the at least one multimedia into at least one of a domain, duration of the corresponding at least one multimedia, a brand, national, vernacular, or a combination thereof.

The method (200) also includes assigning a pre-defined value representative of a weightage associated to the corresponding one or more parameters, based on one or more segregated categories in step 240. In one embodiment, assigning the pre-defined value may include assigning the pre-defined value by a parameter weightage generation module. The method (200) also includes rationalizing data associated to the at least one multimedia to a pre-defined target value in step 250. In one embodiment, rationalizing the data may include rationalizing the data by a multimedia rationalization module.

The method (200) also includes generating a scaling value for each of the at least one multimedia in step 260. In one embodiment, generating the scaling value may include generating the scaling value by a data scaling module. The method (200) further includes generating a score for each of the at least one multimedia based on the scaling value generated to measure effectiveness of an event in step 270. In one embodiment, generating the score may include generating the score by a score generation module.

In one exemplary embodiment, the method (200) may further include predicting a performance of the corresponding at least one multimedia, or a combination thereof using one of an artificial intelligence technique, a machine learning technique or a deep learning technique. In such embodiment, predicting the performance may include predicting the performance by an event prediction module.

Various embodiments of the present disclosure enable the system to generate a unique score which helps in prediction and the weightage of the multimedia being showcased on the social media platforms, impact of such multimedia on the people. The system generates definitive metric for measurement of success for content on Social platforms, thereby making the system more reliable and efficient.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I/we claim:

1. A system (10) to measure effectiveness of an event, wherein the system comprises:
one or more processors (20);
a data retrieving module (30) operable by the one or more processors (20), and configured to retrieve one or more responses corresponding to at least one multimedia, wherein the multimedia is associated to the event;
a multimedia processing module (40) operable by the one or more processors (20), and configured to process the at least one multimedia using a processing technique to identity one or more parameters from the corresponding at least one multimedia;
a multimedia segregation module (50) operable by the one or more processors (20), and configured to segregate the at least one multimedia into one or more categories based on one or more pre-defined set of instructions;
a parameter weightage generation module (60) operable by the one or more processors (20), and configured to assign a pre-defined value representative of a weightage associated to the corresponding one or more parameters, based on one or more segregated categories;
a multimedia rationalization module (70) operable by the one or more processors (20), and configured to rationalize data associated to the at least one multimedia to a pre-defined target value;
a data scaling module (80) operable by the one or more processors (20), and configured to generate a scaling value for each of the at least one multimedia; and
a score generation module (90) operable by the one or more processors (20), and configured to generate a score for each of the at least one multimedia based on the scaling value generated to measure effectiveness of an event.

2. The system (10) as claimed in claim 1, wherein the at least one multimedia comprises one of a text message, an audio message or a video message.

3. The system (10) as claimed in claim 1, wherein the one or more parameters comprises at least one of a like, an emoji, a share, a comments, number of views, cost per click (CPC), cost per visit (CPV), cost per mile (CPM), or a combination thereof associated to the corresponding at least one multimedia, wherein the one or more parameters are decided by one or more viewers.

4. The system (10) as claimed in claim 1, wherein the one or more categories comprises at least one of a domain, duration of the corresponding at least one multimedia, a brand, national, vernacular, or a combination thereof.

5. The system (10) as claimed in claim 1, wherein the scaling value comprises one of a minimum score or a maximum score based on the one or more parameters associated to the event.

6. The system (10) as claimed in claim 1, comprising an event prediction module operable by the one or more processors, and configured to predict one of a status, a performance of the corresponding at least one multimedia, or a combination thereof using one of an artificial intelligence technique, a machine learning technique or a deep learning technique.

7. A method (200) for measuring effectiveness of an event, wherein the method comprises:
retrieving, by a data retrieving module, one or more responses corresponding to at least one multimedia, wherein the multimedia is associated to the event; (210)
processing, by a multimedia processing module, the at least one multimedia using a processing technique for identifying one or more parameters from the corresponding at least one multimedia; (220)
segregating, by a multimedia segregation module, the at least one multimedia into one or more categories based on one or more pre-defined set of instructions; (230)
assigning, by a parameter weightage generation module, a pre-defined value representative of a weightage associated to the corresponding one or more parameters, based on one or more segregated categories; (240)
rationalizing, by a multimedia rationalization module, data associated to the at least one multimedia to a pre-defined target value; (250)
generating, by a data scaling module, a scaling value for each of the at least one multimedia; and (260)
generating, by a score generation module, a score for each of the at least one multimedia based on the scaling value generated to measure effectiveness of an event. (270)

8. The method (200) as claimed in claim 7, wherein identifying the one or more parameters comprises identifying at least one of a like, an emoji, a share, a comments, number of views, cost per click (CPC), cost per visit (CPV), cost per mile (CPM), or a combination thereof associated to the corresponding at least one multimedia.

9. The method (200) as claimed in claim 7, wherein segregating the at least one multimedia into one or more categories comprises segregating the at least one multimedia into at least one of a domain, duration of the corresponding at least one multimedia, a brand, national, vernacular, or a combination thereof.

10. The method (200) as claimed in claim 7, comprising predicting, by an event prediction module, one of a status, a performance of the corresponding at least one multimedia, or a combination thereof using one of an artificial intelligence technique, a machine learning technique or a deep learning technique.
